(19) United States
(12) Patent Application Publication
(10) Pub. No.: US 2021/0250632 A1
(43) Pub. Date: Aug. 12, 2021

(54) SYSTEMS AND METHODS FOR CREATING AND MANAGING VIRTUAL CHANNELS

(71) Applicant: FETCH TY PTY LTD, North Sydney (AU)

(72) Inventors: Michael Penellum, North Sydney (AU); Fred Hopley, North Sydney (AU)

(21) Appl. No.: 16/973,416

(22) PCT Filed: Dec. 13, 2018
(86) PCT No.: PCT/AU2018/051331

§ 371 Date: Dec. 8, 2020

(30) Foreign Application Priority Data
Jun. 15, 2018 (AU) 2018902141

(51) Int. Cl. H04N 21/2668; H04N 21/262; H04N 21/462; H04N 21/472; H04N 21/4722; H04N 21/431

(52) U.S. Cl. CPC H04N 21/2668; H04N 21/26208; H04N 21/4314; H04N 21/47202; H04N 21/4722; H04N 21/4622

(57) ABSTRACT

Disclosed herein are systems and methods for creating and managing virtual channels. A method performed at a content distribution system for displaying a virtual broadcast channel on a user device comprises: creating the virtual broadcast channel, the virtual broadcast channel comprising an ordered list of media items; generating and associating a channel metadata descriptor with the virtual channel and a media item metadata descriptor with each media item in the virtual channel, the media item metadata descriptor comprising data indicating the order of play of the media items and an action to be performed in association with a particular media item of the virtual broadcast channel; forwarding the channel metadata descriptor and the media item metadata descriptors to a user device for rendering an electronic program guide, the electronic program guide comprising a listing of the virtual broadcast channel; receiving, from the user device, a request for a media item from the ordered list of media items, the media item scheduled to play at the current time, the request received in response to the user device detecting selection of the virtual channel on the user device; and retrieving and forwarding the requested media item to the user device for rendering on a display associated with the user device.

### TECHNICAL FIELD

Aspects of the present disclosure are directed to content management systems and in particular to creation and management of virtual media channels.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Traditionally, media content providers either provided media content over the air (e.g., broadcast media content) or via the Internet (e.g., VOD streaming services). The last decade however has seen a significant increase in the number of digital media content delivery systems and providers that provide media content via a combination of these delivery technologies. For example, service providers such as Fetch® provide free to air broadcast media content, premium broadcast media content, and video on demand content allowing users to watch TV shows broadcast on free to air TV, movies on premium broadcast channels, stream TV shows via video streaming applications such as Netflix® or Hayu®, or buy movies available on a VOD server all through the same set top box or mobile application.

Although this overabundance of media content is good for customers, selecting a particular show or movie on any given day can be overwhelming. Additionally, manually searching through the disparate delivery systems separately to find content can be inefficient—often leading customers to perform lengthy searches and then completely abandoning the idea of watching TV because of the crippling idea of committing to something without knowing all their options and without knowledge of whether the user will eventually be interested in the content.

Currently there is no single avenue for users to review multiple media items available via different delivery technologies. Often, users may switch between their televisions and portable electronic devices before they can select a particular media item to watch or purchase—e.g., viewing media items listings on the television and reviewing selected items using their portable electronic devices. Further, there is no way for a user to know or peruse media items in a particular category (e.g., thriller movies) available via the different media delivery technologies the user has access to other than perusing the content available on each media delivery technology separately.

It will be appreciated that this can be burdensome for the user and an inefficient way of using electronic devices and network bandwidth.

### SUMMARY

According to a first aspect of the present invention there is provided a method for displaying a virtual broadcast channel on a user device, comprising: creating the virtual broadcast channel, the virtual broadcast channel comprising an ordered list of media items; associating metadata with the virtual channel and with each media item in the virtual channel, the metadata indicating the order of play of the media items and an action to be performed in association with a particular media item; forwarding the metadata associated with the virtual channel and the media items to a user device for rendering an electronic program guide, the electronic program guide comprising a listing of the virtual broadcast channel; receiving a request for a media item from the ordered list of media items, the media item scheduled to play at the current time, the request received in response to the user device detecting selection of the virtual channel on the user device; and retrieving and forwarding the requested media item to the user device for rendering on a display associated with the user device.

According to a second aspect of the present invention there is provided a method for engaging with a media item of a plurality of media items available in a virtual broadcast channel on a user device, the method comprising: playing the media item on a display associated with the user device, along with a user interface affordance for performing an additional action associated with the media item; receiving indication of selection of the user interface affordance; retrieving metadata associated with the media item to identify an action corresponding to the selected user interface affordance, and performing the corresponding action.

According to a third aspect of the present disclosure there is provided a system for displaying a virtual broadcast channel on a user device, the system comprising a processor and a memory for storing instructions, which when executed by the system, cause the system to: create the virtual broadcast channel, the virtual broadcast channel comprising an ordered list of media items; associate metadata with the virtual channel and with each media item in the virtual channel, the metadata indicating the order of play of the media items and an action to be performed in association with a particular media item; forward the metadata associated with the virtual channel and the media items to a user device for rendering an electronic program guide, the electronic program guide comprising a listing of the virtual broadcast channel; receive a request for a media item from the ordered list of media items, the media item scheduled to play at the current time, the request received in response to the user device detecting selection of the virtual channel on the user device; retrieve and forwarding the requested media item to the user device for rendering on a display associated with the user device.

According to a fourth aspect of the present disclosure there is provided a user device for engaging with a media item of a plurality of media items available in a virtual broadcast channel, the user device comprising a client application configured to: play the media item on a display associated with the user device, along with a user interface affordance for performing an additional action associated with the media item; receive indication of selection of the user interface affordance; retrieve metadata associated with the media item to identify an action corresponding to the selected user interface affordance, and perform the corresponding action.

According to a fifth aspect of the present disclosure there is provided a method of rendering a graphical user interface for a user device, the method comprising: at the user device presenting an electronic program guide, wherein the electronic program guide is based on data received by the user device from a remote media system; receiving at the user device interactions to display the electronic program guide including a first schedule for a first channel and a second schedule for a second channel, different to the first channel; displaying the first channel in the electronic program guide showing the individual media items arranged in a timeline according to the first schedule; displaying the second channel in the electronic program guide showing the currently playing media item, wherein the currently playing media items extends across a display area of the electronic program guide over a greater extent than the duration of the item would indicate if displayed in the first channel.

### BRIEF DESCRIPTION OF THE DRAWINGS

In the drawings:

FIG. 1 is a block diagram of a networked environment according to some embodiments of the present disclosure.

FIG. 2A is a screenshot of an example EPG user interface according to some aspects of the present disclosure.

FIG. 2B is a screenshot of an example EPG user interface according to some other aspects of the present disclosure.

FIG. 3A is a flowchart illustrating a method for creating virtual channels according to some embodiments of the present disclosure.

FIG. 3B is a flowchart illustrating a method for displaying virtual channels according to some embodiments of the present disclosure.

FIG. 4 is a screenshot of an example virtual channel according to some aspects of the present disclosure.

FIG. 5 is a screenshot of the virtual channel of FIG. 4 when a subscriber has navigated to a different media item.

FIG. 6 is a flowchart illustrating a method for interacting with media content on a virtual channel according to some embodiments of the present disclosure.

FIG. 7 is a screenshot of the virtual channel of FIG. 4 with a detailed information bar according to some aspects of the present disclosure.

FIG. 8 is a screenshot of the virtual channel of FIG. 4 with a UI affordance for more information according to some aspects of the present disclosure.

FIG. 9 is a screenshot displaying the screen when a subscriber has selected a “more information” affordance according to some embodiments of the present disclosure.

FIGS. 10-13 are screen shots of example virtual channels with a “more information” affordance displayed in a top right corner according to some embodiments of the present disclosure.

FIG. 14 is a block diagram of a computing system with which various embodiments of the present disclosure may be implemented.

While the invention is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the spirit and scope of the present invention as defined by the appended claims.

### DETAILED DESCRIPTION

In the following description, for the purposes of explanation, numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

Aspects of the present disclosure are related to the creation and management of virtual broadcast channels. In certain embodiments, previews of media content available via one or more disparate platforms (e.g., broadcasted content and VOD content) may be made available via a virtual broadcast channel. Further, each media item on the virtual broadcast channel may be associated with one or more actions that when invoked allow a subscriber to interact with the media content in a meaningful manner.

For instance, in one example, a digital media content aggregator may create a virtual broadcast channel to include a list of trailers for media items (e.g., TV shows or movies available via the content aggregator). Each of the plurality of trailers may correspond to a media item available to a subscriber, for example for purchase or viewing as video on demand. Alternatively, the trailers may correspond to TV shows currently being aired on one or more broadcast channels. When creating the playlist for the virtual broadcast channel, the content aggregator adds metadata for each trailer—the metadata providing a link to a user interface that provides additional information about the corresponding media item. When a subscriber engages with the virtual broadcast channel using their electronic device (e.g., set top box (STB) or portable electronic device), a user interface affordance may be displayed informing the subscriber that additional information is available. For example, the user interface affordance may be displayed whilst a media item (e.g. trailer) is being displayed. When this is selected, the electronic device may be programmed to automatically navigate, based on the metadata for the media item, to the linked user interface where the subscriber may be able to read additional information about the media item, purchase the media item, navigate to a broadcast channel showing the corresponding media item, add the corresponding media item in their favorites list, record the media content, etc.

In another example, a virtual broadcast channel may be created to play a list of videos, e.g., “how to” videos explaining features of a device, for example an STB or application running on a computer or mobile device that can access the list of videos. The metadata associated with each of the videos may include links/pointers that navigate the subscriber to portions of the user interface where the subscriber may be able to implement/practice what they've learnt through the video.

It will be understood that these are merely examples of the contemplated virtual broadcast channels and virtual broadcast channels can be created for any other purposes without departing from the scope of the present disclosure. For example, virtual broadcast channels may be created to showcase the top rated TV shows currently available via one or more mediums, the highest viewer rated movies available for purchase, etc.

By creating a virtual channel of this nature, aspects of the present disclosure enhance user experience by allowing users to peruse media content offered by the content delivery platform at one location. Further, by incorporating one or more actions associated with media items of the virtual channel within the virtual channel, users can directly interact with the media content from the virtual channel and need not manually navigate to the broadcast channel or VOD provider to obtain further information or interact with the media item in a meaningful manner. Therefore, aspects of the present disclosure provide a more intuitive human-machine interface that can accelerate the user's selection of content to consume. Further, the disclosed systems and methods may prevent unnecessarily navigating back and forth between channels or media delivery technologies.

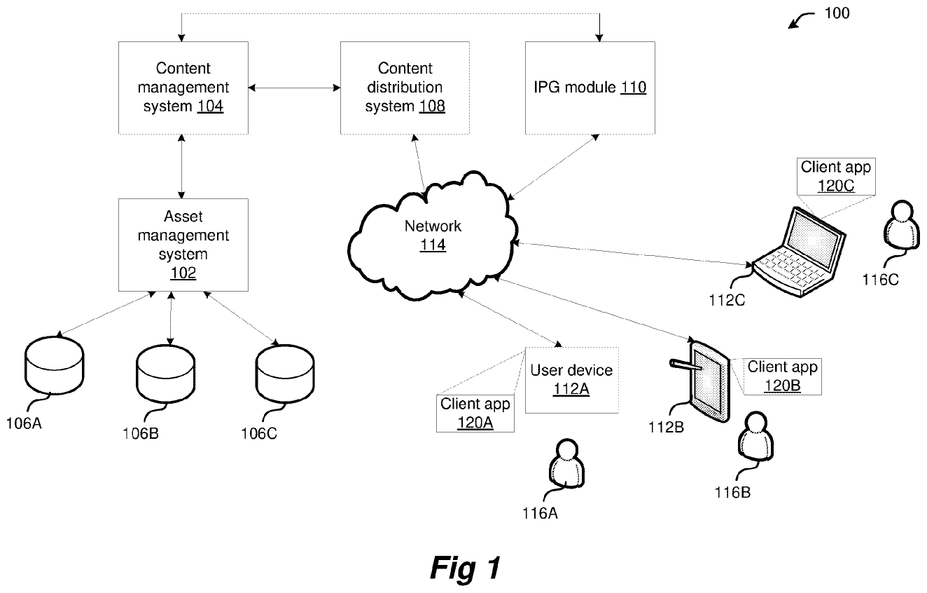

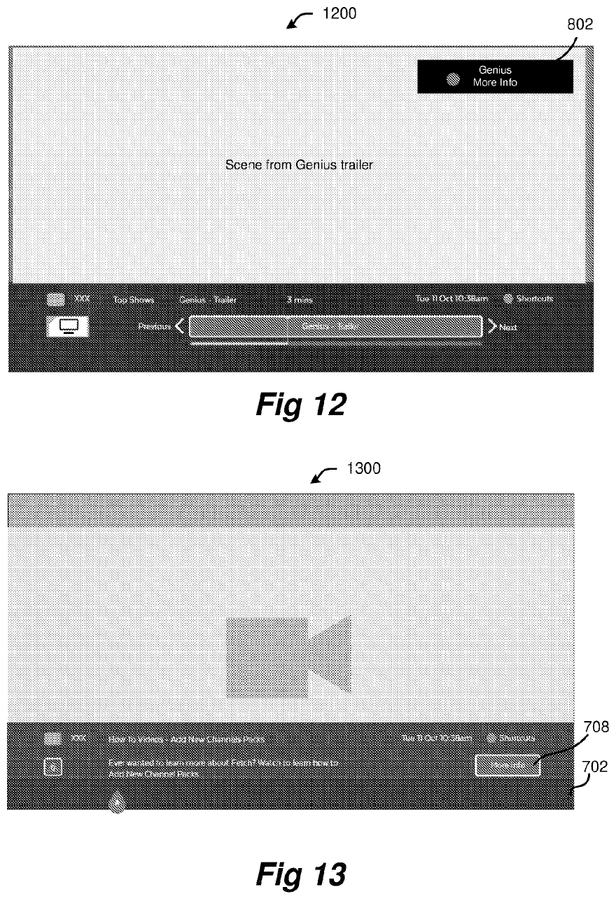

These and other aspects of the present disclosure will be described in detail with reference to FIGS. 1-14 below.

### Environment Overview

FIG. 1 illustrates an environment 100 in which one or more aspects of the present disclosure are implemented. Specifically, FIG. 1 illustrates the systems involved in creating, maintaining and managing virtual broadcast channels. The systems include an asset management system 102, a content management system 104, media content sources (e.g., media content sources 106A, and 106B, collectively referred to as data sources 106), content distribution system 108, an interactive program guide (IPG) module 110 and user devices (e.g., client devices 112A, and 112B, and 112C, collectively referred to as client devices 112). The various systems in environment 100 communicate with each other over one or more communication networks 114. The asset management system, content management system, IPG module 110 may be part of/hosted by a service provider (e.g., Fetch®) that provides broadcast and video on demand content to subscribers 116 via the content distribution system 108.

The asset management system 102 is responsible for receiving media content from originating media sources 106. The digital media may be stored in the form of one or more media files in one or more databases maintained by the asset management system 102. It will be appreciated that these databases may be maintained locally or remotely (e.g., via a cloud platform). Alternatively, the media may be accessed when required from the relevant media source 106, in which case the asset management system 102 may store an identifier of the media item and an associated location or address where the media item can be accessed. The content may be any form of media, such as images, audio or video associated with archives, previously recorded content or content associated with live feeds. In some cases, the content may be supplied on removable media, such as digital versatile diskettes (DVD's), memory sticks, compact disks (CD's), etc. and uploaded to a location in the network 114, such that the asset management system 102 can access the content from the network 114.

When storing the media items, the asset management system 102 may assign unique identifiers to each of the stored media items. In some embodiments, the identifier may be a combination of an identifier for the provider of the media item and a title of the media item.

In addition to storing digital content, the asset management system 102 is configured to service media item requests received from the content management system 104. Consider one example where the content management system 104 transmits a request for a particular media item to the asset management system 102, the request comprising a media item identifier (that uniquely identifies the media item). The asset management system 102 in this example, identifies the requested media item from the item identifier, retrieves the media item and forwards it to the content distribution system 108.

The content management system 104 is configured to receive media items from the asset management system 102 and organize/prepare the media items for distribution to user devices 112. In certain embodiments, the content management system 104 may be configured to associate metadata with each of the media items stored by the asset management system 102. The metadata may include a variety of information, such as but not limited to, a category for the media item (e.g., family, sports, kids, adult, etc.), descriptive information for the media item (e.g., title, cast, year), indexing information for scenes embedded within the media item, identifiers for the media item provider, identifiers for the originating media source 106, identifiers or information for media item licenses, data format type, length or size of the media item, and the like.

In certain embodiments, the media items may be prepared for distribution based on one or more rules or conditions. The rules may be identified based on metadata associated with the media items, such as unique item identifier, data format type of the item, a media category, an identifier for an originating media source 106, an identifier for a provider of the media item, and/or various combinations of some or all of these. Moreover, the rules may be processed by the content management system 104 on all of the media items, on a specific media item, or on selective and statically or dynamically determined groupings of media items. So, rules may be locally or globally enforced. The rules drive the processing of the content management system 104 to distribute, organize, prioritize, and update the media items, and/or generate reports about different aspects of the media items.

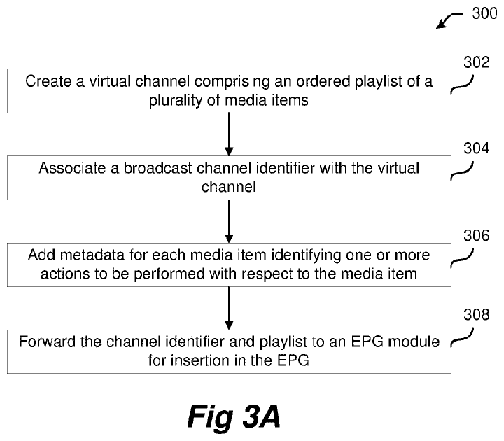

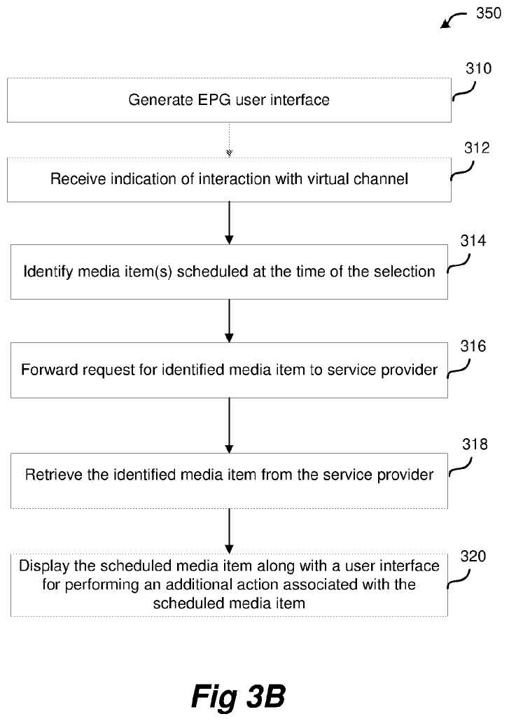

In addition to managing and distributing media items from the asset management system 102, the content management system 104 may be configured to create virtual channels. To this end, the content management system 104 may be configured to select multiple media items (e.g., trailers of movies or shows available for purchase, promos of movies or shows currently available for viewing on one or more broadcast channels, how to videos, etc.), create a broadcast schedule to play the media items, assign a broadcast channel identifier to the playlist, forward the schedule to the IPG module 110, and create metadata for the virtual channel and for each of the media items in the virtual channel playlist. The process of creating a virtual channel is described in detail with reference to FIG. 3.

The content distribution system 108 is responsible for delivering media items over the communication network 114 in data formats and using network protocols expected by the user devices 112 specific to a target subscriber 116. The content distribution system 108 may also alter, optimize, and manage that delivery or distribution process.

Media items/assets may be delivered to the electronic devices 112 using a variety of distribution techniques including unicast (in case video on demand content is requested), multicast (if a media item is requested by multiple subscribers 116 at roughly the same date and time), or broadcast via cable/satellite. Thus, the content distribution system 108 is responsible for ensuring that assets are optimally delivered to target subscriber(s) 116.

The IPG module 110 is configured to receive metadata of the broadcast channels and the video-on-demand (VOD) content hosted by the asset management system 102. In certain embodiments this metadata is provided by the content management system 104. In case of broadcast channels, the IPG module 110 is configured to create schedules of media items running on each of the broadcast channels for a predetermined period of time (e.g., up to 7 days in the future and in case catch-up TV is available, up to 7 days in the past). In case of VOD content, the IPG module 110 is configured to create a list of all the media assets available for a particular subscriber account. This information is then forwarded to the corresponding electronic device 112.

It should also be noted, that although the asset management system 102, the content management system 104, the content distribution system 108, and the IPG module 110 are shown as separate entities, two or more of these entities may logically function as a single service provided by a service provider. Equally, services provided by any one of the entities may be divided and provided by more than one entity. So, the architecture depicted in FIG. 1 is shown for purposes of illustration only, since more components or less components or entities may be used without departing from the teachings presented herein.

The user devices 112 may be any device suitable for performing client-side operations described herein, for example a set top box (STB), a mobile device (e.g. a tablet or mobile phone), a portable device (such as laptop computer), or any other computing device (e.g. a desktop computer).

Generally speaking, subscribers 116 of the service provider utilize the user devices 112 to access the media content hosted by the service provider. To do this, subscribers 116 are associated with a user account maintained by the service provider that informs the service provider of the particular broadcast channels and VOD media content the subscriber has subscription to. This account information, e.g., account identifier and/or user identifier, is stored in the user device 112 and forwarded to the content management system 104 whenever access to a particular media item is requested. The content management system 104 in turn compares the account identifier with those stored at the content management system 104 to determine whether the subscriber is allowed to access the requested media item.

In order to access media content, each client device 112 includes one or more client (software) applications (e.g., client applications 120A and 120B) that are configured to interact with the service provider systems. The client applications 120 include instructions and data stored in the memory (e.g. non-transient compute readable media) of the client devices 112 on which the applications are installed/run. These instructions are executed by a processor of the client device 112 to perform various functions as described herein. By way of example, some functions performed by the client applications 120 include communicating with the IPG module to retrieve channel and media item metadata and corresponding IPG information, communicating with the content management system 104 to place requests for media items, receiving media content from the content broadcast system 108, and rendering user interfaces based on instructions received from those systems.

In particular, the client application 120 is configured to process information received from the IPG module 110 and render a user interface for displaying information about the media items/channels provided by the service provider, as an electronic program guide (EPG). Conventionally, in case of broadcast content, the EPG user interface is displayed as a grid. The vertical axis of the grid displays the available broadcast channels and the horizontal axis of the grid displays the time. Each intersection of the vertical axis (channel) with the horizontal axis (time) displays an airing of a broadcast media item. The viewer may scroll along both the horizontal axis and vertical axis to identify television programs being broadcast at different times and on different channels.

In certain embodiments, a schedule of one or more virtual channels may also be displayed in the EPG user interface. In case the virtual channel is programmed to play short duration media items (e.g., trailers or promos that last 2-5 minutes), the EPG interface for virtual channels may not show the title and duration of each media item along the time axis. Instead, the EPG may display the channel title and/or the title of the media item currently playing.

In addition, the electronic devices 112 may include typical components for processing media items such as tuner receivers, a demodulator, a demultiplexer, a decryptor/descrambler, a decoder, a modulator/output interface, a media storage device, local memory, a microprocessor, a power supply and a remote control.

A subscriber 116 may interact with the virtual channels and the media items hosted on the virtual channels via the electronic device 112. For instance, a subscriber 116 uses an input selection device, such as a remote associated with a TV and/or the electronic device 112 and selects a particular virtual channel for delivery and viewing (e.g., either via the EPG user interface 200 or by directly entering the channel identifier (e.g., 100) via the remote). Upon selection of the virtual channel, the electronic device 112 retrieves the channel identifier and the item identifier of the media item currently playing on the virtual channel and forwards this information to the content management system 104 over the network 114. The content management system 104 retrieves the corresponding media item from the asset management system 102 prepares it for distribution (e.g., encodes the media file for streaming) and forwards the media item to the content distribution system 108. The content distribution system 108, in turn, delivers the selected media item to the electronic device 112 for viewing on a display associated with the electronic device (e.g., an external television or an integrated display).

As illustrated in FIG. 1, communications between various system elements are via the communications network 114. The communication network 114 is depicted as a single network in FIG. 1 for ease of depiction. However, in actual implementation, the various systems may communicate with each other over different communication networks. For example, the asset management system 102, the content management system 104, and the IPG module 110 may communicate through a local area network (LAN), whereas the content distribution system 108 may communicate with the user devices 112 via a public network (e.g., the Internet), cable, or satellite.

It will be appreciated that although only three user devices (112A, 112B, and 112C) and three data sources (106A, 106B, and 106C) have been depicted, in normal operation, many more user devices 112, and data sources 106 may be connected to the service provider systems through the network 114.

### Exemplary methods

FIG. 3 illustrates an exemplary method for creating and displaying virtual channels. For ease of description, this method is divided into sub-processes 300 and 350, where sub-process 300 is carried out by the service provider and sub-process 350 is carried out at the user device 112. In particular, FIG. 3A illustrates a process for creating virtual channels and FIG. 3B illustrates a process for displaying virtual channels.

The method 300 begins at step 302, where a virtual channel is created. The virtual channels may be created manually, for example by an employee of the service provider, or automatically by the content management system 104. In case of automatic generation, the content management system 104 may be configured to identify multiple media items for the virtual channel based on one or more conditions that are determined as satisfied or not satisfied based on data received by the content management system 104. For example, the content management system 104 may be configured to create a virtual channel of trailers of the ten highest rated television shows/movies available on a video streaming application such as Netflix or Hayu. Similarly, the content management system 104 may be configured to create a virtual channel of trailers of the ten newest movies/television shows added to the inventory of a video streaming application. As another example, the content management system 104 may be configured to create a virtual channel showing the first episodes of televisions shows with the highest critic reviews available on broadcast channels. It will be appreciated that when the content management system 104 is configured to create virtual channels automatically, the media items in the playlist may also be automatically updated (e.g., based on the real time ratings of media items, or when new media items are added to the asset management system 102).

At step 304, a unique channel identifier is associated with the virtual broadcast channel. The channel identifier is the number displayed next to the channel title in the electronic program guide and the number a subscriber 116 presses on their remote control of the set top box to directly land on the broadcast channel. In certain embodiments, the content management system 104 may associate the next available channel identifier with the newly created virtual channel.

At step 306, a metadata descriptor is created for the virtual channel and individual metadata descriptors are created for each of the media items in the channel. As above, the metadata descriptors may be created automatically by the content management system 104 or manually by an employee of the service provider.

The channel metadata descriptor includes information relevant to the virtual channel, including e.g., fields that indicate whether the virtual channel is active or not, a unique channel identifier for the virtual channel, the types of media items on the virtual channel, the format of media items on the virtual channel, a start time of the virtual channel, and an order of play of the media items on the virtual broadcast channel. The metadata descriptor for each of the media items on the virtual channel may include fields that indicate the title of the media item, identifier of the media item, media item type, order of play in the playlist, and a link to additional information about the media item. It will be appreciated that these metadata fields are merely exemplary and that any other metadata fields to identify the media item may be utilized without departing from the scope of the present disclosure.

Table A illustrates the channel metadata associated with an example virtual channel:

TABLE A
Virtual channel metadata descriptor

| | |
|---|---|
| Status: | Enabled |
| Channel title: | Movies Now Showing |
| Channel identifier | 100 |
| Location type: | Editorial |
| Catalogue tab path: | trailer_avc |
| Default asset type: | HLS Trailer |
| Default content format: | SD |
| Start time: | 1:24 p.m. |
| Description | Previews of the latest blockbuster |
| | movies ready to watch now. |
| | Previews may be rated PG or M |

In the example virtual channel metadata descriptor, for each unique virtual channel, the following information is added:
Status of the channel, e.g., enabled, disabled.
Title of the virtual channel, which is “Movies now showing” in this example.
A channel ID to uniquely identify the virtual channel.
Location type of the virtual channel. This may have one of two values—Editorial or automatic. Editorial indicates that the virtual channel was specified and updated manually by an operator, whereas Automatic indicates that the virtual channel was generated automatically based on a set of rules or by input from another system.
Catalogue tab path, which indicates the file name and filepath of the file where the actual playlist for the virtual channel is stored
Default Asset type, which indicates the type of channel. In the example shown in Table A, the virtual channel is an http live stream (HLS) of trailers.
Format of the media items on the channel. In this example, all the media items have a standard definition (SD) format.
Start time, which indicates the time at which the first item in the virtual channel is scheduled to play. In this example, the start time of the playlist is 1:24 pm each day.
A short description of the channel—this is displayed on the EPG and is used to give a brief description of the content available on that particular channel.

Table B illustrates the metadata descriptor associated with two example media items in the example virtual channel “Movies now showing”:

TABLE B
Media item metadata descriptor

| | |
|---|---|
| Item ID: | 595004 |
| Item Title: | 6 Days - trailer |
| Item type | VOD |
| Duration: | 2 mins |
| Text | 6 Days is a British-New Zealand biographical |
| | action film directed |
| | by Toa Fraser and written by Glenn Standring |
| Image | |
| Color | |
| Settings: | promo_for_type = VOD, promo_for_id = |
| | 595004, promo_for_view = movies |
| Order of play | 1 |
| Item ID: | 604674 |
| Item Title: | The Foreigner - Trailer |
| Item type | VOD |
| Duration: | 2 mins |
| Text | The Foreigner is a 2017 action thriller |
| | film directed by Martin Campbell and written |
| | by David Marconi, based on the 1992 novel |
| | The Chinaman by Stephen . . . |
| Image | |
| Color | |
| Settings: | promo_for_type = VOD, promo_for_id = |
| | 604674, promo_for_view = movies |
| Order of play | 2 |

In the example table above, for each unique media item, the following information is added:
An item identifier to uniquely identify the media item.
Title of the media item
Type of the media item, e.g., whether it is broadcast content or video on demand content.
Duration of the media item.
A text field that includes a brief synopsis/summary of the media item content
An image, such as a background image associated with the media item.
Color indicates the screen color to be displayed before the image of the media item loads.
Settings. This field includes a link/path/address of the user interface the client application 120 is supposed to navigate to in case the subscriber 116 engages with the corresponding media item.
The order of play, which indicates when the particular media item is to be played in the virtual channel schedule.

In the examples above, the channel metadata descriptor and the item metadata descriptors are illustrated in separate tables. In certain embodiments, each channel metadata descriptor may be stored in a channel database that stores metadata associated with each of the broadcast channels provided by the service provider and each media item metadata descriptor may be stored in a media item database that stores metadata associated with each of the media items managed by the asset management system 102. In other embodiments, the channel and media item metadata descriptors for virtual channels may be maintained in a virtual channel database.

Returning to FIG. 3A, at step 308, the channel and media item metadata descriptors for the virtual channel is forwarded to the IPG module 110. The IPG module 110 updates the broadcast information with metadata associated with the virtual channel and provides the updated IPG information to the user electronic devices 112 for rendering on a display associated with the electronic device 112.

Turning now to FIG. 3B, the method 350 begins at step 310 where the client application 120 on a user device 112 uses IPG information received from the IPG module 110 to generate an EPG user interface including a grid of broadcast channels and the corresponding broadcast media items scheduled on the broadcast channels.

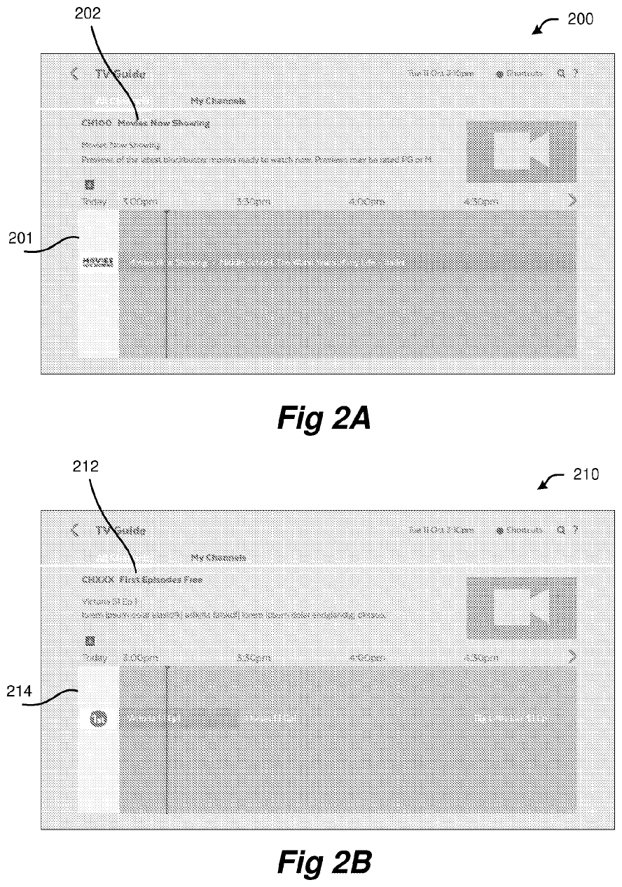

FIG. 2A illustrates an example EPG user interface 200 showing an example virtual channel 202 (“Movies now showing”). As seen in FIG. 2A, the user interface 200 displays the channel identifier “CH100”, the channel title, “Movies now showing”, and description of the virtual channel, “Previews of the latest blockbuster movies ready to watch now. Previews may be rated PG or M”. This information is retrieved from the channel metadata descriptor shown in table A above. In addition, the user interface 200 displays a channel schedule in grid 201. In this particular example, the duration of each of the media items is about 2 minutes and therefore it may not be feasible to show the timing information of each media item in the grid 201. Accordingly, in this example, the EPG user interface displays the media item title, i.e., “Middle school: the worst years of my life—trailer” of the media item that is currently scheduled to play on the virtual channel along the time axis for this virtual channel 202. It will be appreciated that the title of the media item in the grid 201 may update in real time depending on which media item is currently playing. For example, if the subscriber 116 stays on user interface 200 for a duration that is longer that the duration of a currently playing media item, the title for the virtual channel in the grid 201 will change to show the next playing media item on that channel.

FIG. 2B illustrates another example EPG user interface 210 showing an example virtual channel 212 (“First Episodes Free”), which is created to play the first episodes of new TV shows. In this particular example, the duration of each of the media items is at least 30 minutes and therefore the timing information for each of the media items is shown in the grid 214.

In both the example user interfaces shown above, in order to display the currently playing item or the schedule of media items, the client device 120A has to determine what is currently playing. To do this, the client application 120 is configured to retrieve the playlist for the virtual channel from the location available in the metadata descriptor field “catalogue tab path”. Then, based on the current time, the start time for the virtual channel (again determined from the metadata descriptor), the order of play of the playlist, and the duration of each media item, the client application 120 determines which media item is currently set to play and the playtime of subsequent media items. This information is utilised to populate the grid 214.

Further, the decision to display either the title of the currently playing media item or a schedule of multiple media items in the grid 214 can be automatically made by the client application 120 based on the duration of the media items in the playlist. If the average duration of the media items is below a threshold duration, the client application 120 may be configured to display the title of the currently playing media item. Alternatively, if the duration of the media items is above a threshold duration, the client application 120 may be configured to display a schedule of the media items.

Returning to FIG. 3B, at step 312, the client application 120 receives an indication of the subscriber 116 selecting a particular virtual channel 202 (e.g., via the EPG user interface or by selecting the virtual channel identifier (or number) via a remote control of the user device 112).

Next (at step 314), the client application 120 retrieves the item identifier of the media item currently playing on the selected virtual channel, e.g., from the media item metadata descriptor.

At step 316, the client application 120 generates a request for the identified media item and forwards this request (including the item identifier) to the content management system 104. The content management system 104 in turn retrieves the corresponding media item from the asset management system 102, prepares it for distribution, and forwards it to the content distribution system 108 for forwarding to the user device 112. Consequently, at step 318, the client application 120 receives the requested media item from the server provider.

At step 320, the client application 120 is configured to display the scheduled media item. Thereafter, a subscriber 116 may interact with the media item (e.g., the subscriber may switch between media items by going forward or backwards in the scheduled list of media items, or navigate to a user interface showing more information about the media item).

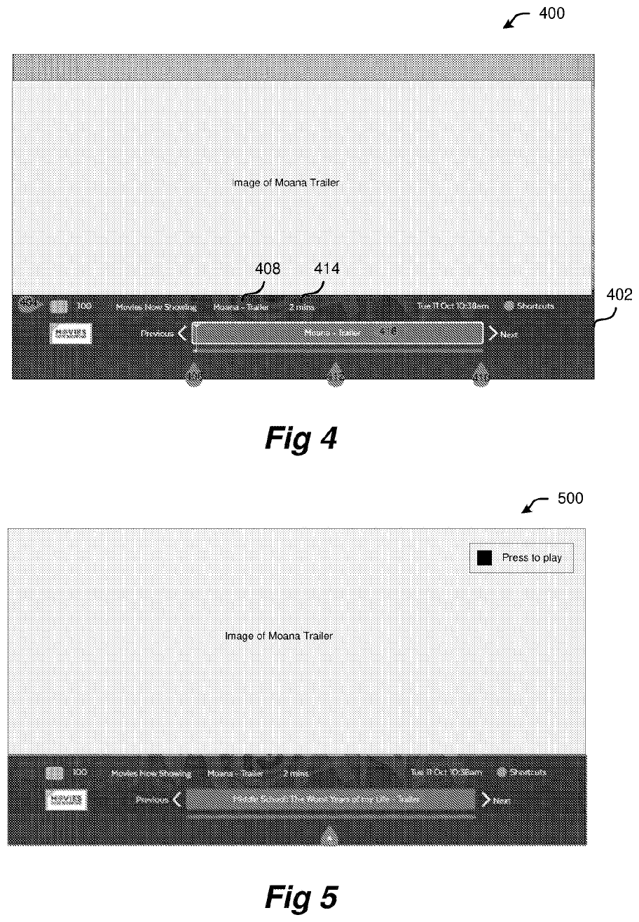

FIG. 4 illustrates an example screenshot 400 of a particular media item playing on a virtual channel. In particular, the example screenshot is of the Moana trailer playing on the “Movies now showing” virtual channel. As seen in the screenshot, the bottom portion of the virtual channel display includes an information bar 402 providing information about the virtual channel and the media items in that particular virtual channel. Example pieces of information in the information bar 402 include an icon 404 for the virtual channel, an indicator 406 for returning to the previous media item in the playlist, the title of the currently playing media item 408, an indicator 410 for navigating to the next media item in the playlist, a progress bar 412 indicating progress of the media item while it is playing, and an indicator 414 of the duration of the media item.

It will be appreciated that the order of this information and the type of information displayed in the information bar 402 is merely exemplary and any other information related to media items may also be displayed without departing from the scope of the present disclosure.

In case the virtual channel is displayed on a user device 112 with a touch screen, the indicators can be user interface affordances that a subscriber 116 can directly engage with to interact with the media item.

Alternatively, if the virtual channel is displayed on a television connected to a set top box (STB), a remote control associated with the STB may be utilized to interact with the media item. In this case, certain buttons of the remote control may be configured to cause certain actions to happen. For instance, the left direction button on the remote control can be associated with the returning to the previous media items in the playlist, the right direction button can be associated with navigating to the next media item and the center, select or enter button can be associated with selecting a particular action. Accordingly, if the STB detects that the subscriber 116 has selected the left direction button, the STB may be configured to update the title of the media item in the progress bar to show titles of previous media item(s). Similarly, if the STB detects that the right direction button is selected on the remote control, the STB may be configured to update the title of the media item in the progress bar to show titles of the next media item(s). Similarly, if selection of the ‘select’ or ‘enter’ button is detected, the STB may be configured to do nothing if the title displayed in the progress bar matches the title of the currently playing media item. Alternatively, if the title displayed in the progress bar does not match the title of the media item currently playing, the set top box may be configured to play the media item corresponding to the title in the progress bar.

FIG. 5 illustrates a screenshot 500 where the Moana trailer is playing but the subscriber has navigated forward to the next media item, i.e., “Middle school: the worst years of my life” trailer. In this case, when the subscriber selects the ‘select’, ‘play’, or ‘enter’ button on the remote control, the user device 112 replaces display of the Moana trailer with display of the Middle school trailer.

Accordingly, although the virtual channel has an associated broadcast channel identifier and appears in the EPG as any other broadcast channel, subscribers can interact with the content of the virtual channel (e.g., go forward or backwards in the playlist to play content) unlike a traditional broadcast channel. For example, if either of the indicators 406 or 410 are selected, the operation of the system changes from a scheduled broadcast mode for the user device into an on demand mode for that user device 112. Additional interactions possible on the virtual channel include playback fast forward, playback rewind, and playback pause.

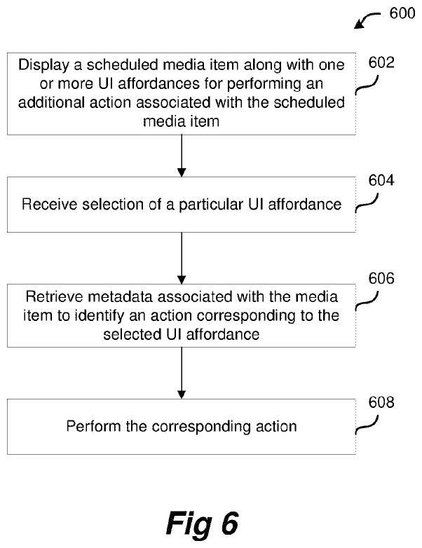

FIG. 6 is a flowchart illustrating a method 600 for interacting with media content on a virtual channel according to some embodiments of the present disclosure. The method begins when a subscriber 116 selects a particular virtual channel for viewing. At step 602, the user device 112 is configured to retrieve the media item that is currently scheduled to play on the virtual channel and render this on the display. Further, the user device 112 is configured to display an affordance for performing an additional action associated with the scheduled media item.

This affordance may be displayed in many different ways. In certain embodiments, in addition to the information bar, a detailed information bar may be associated with the media item. FIG. 7 illustrates a screenshot 700 displaying the detail information bar 702. As seen in the figure, the detailed information bar includes the channel icon 404, the channel identifier 704, the media item title 408, a synopsis/description of the media item currently playing 706, and a “more information” affordance 708. The subscriber 116 can toggle between the information bar 402 and the detailed information bar 702, for example, by selecting the [i] button on the remote control or selecting a toggling affordance (not shown) such as a back/forward button on the information bar and detailed information bar.

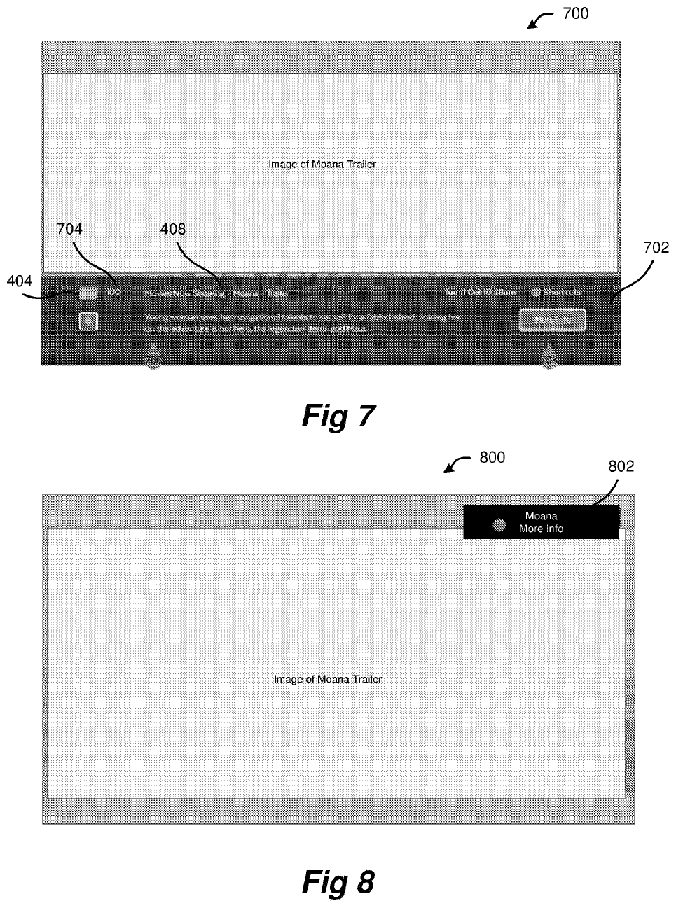

In other embodiments, the “more information” affordance may be displayed at another location on the display (e.g., in the top right corner of the display). The affordance may be displayed after a predetermined duration (e.g., after 1 minute of the media item playing) or just before the media item is about to complete playing (e.g., 20 seconds before media item completes playing). This gives the subscriber sufficient time to view the media item and determine whether the subscriber 116 is interested in the media item or not. Alternatively, the “more information” affordance may be displayed continuously. FIG. 8 illustrates a screenshot 800 of a media item playing and the “more information” affordance 802 being displayed in the top right corner of the display.

Next, the subscriber selects the “more information” affordance 702 or 802. Depending on the type of user device, the “more information” affordance may either be an interactive control (in case of touchscreen devices) or it may be an informative affordance (in case of STBs) advising the subscriber which button on the remote control of their STB should be selected if the subscriber wishes to further engage with the content of the media item currently playing on the display. In any case, at step 604, the user device receives selection of the “more information” affordance.

Next, at step 606, the user device is configured to retrieve the metadata associated with the media item to identify an action corresponding to the selected “more information” affordance. In one example, the client application 120 retrieves the metadata value corresponding to the “settings” field to identify the location/address of the user interface the client application is supposed to navigate to. As described previously, different types of virtual channels can be created for playing different types of content (broadcast content, VOD content, how to videos, etc.). Depending on the type of content, different types of actions can be associated with the virtual channel and the action type can be indicated in the settings field of the metadata associated with the media items. For example, if the virtual channel plays trailers of VOD content, the metadata associated with each of the trailers can provide a link to the detailed information page associated with the VOD item corresponding to the trailer. Similarly, if the virtual channel plays the first episodes of shows being broadcast on free to air channels, the settings field in the metadata associated with each of the first episodes can provide a link to the broadcast channel on which the show is aired, or to a user interface that provides an option to record the complete season when it is aired on the corresponding broadcast channel. As another example, if the virtual channel plays the first episodes of shows available on video on demand channels, the settings field in the metadata associated with each of the first episodes can provide a link to the user interface associated with the corresponding show that provides an option to watch and/or purchase the next episodes in the series. In the example of how to videos, the settings field in the metadata associated with each how to video can provide a link to another portion of the EPG user interface where the subscriber 116 can perform the task explained in the corresponding how to video.

At step 608, the client application 120 navigates to the address/location indicated in the settings field of the metadata associated with the media item. In certain embodiments, the user interface to which the media item is linked may be displayed overlaid on top of the currently playing media item on the virtual channel. This way, the user device 112 does not navigate away from the virtual channel, but allows the subscriber 116 to interact with the media item and/or view additional information about the media item while displaying the currently playing media item in the background. In other embodiments, the user device 112 may navigate to the user interface to which the media item is linked. In such cases, once the subscriber has engaged with the additional information, an option to return to the virtual channel may be provided. This way, the user does not have to manually navigate back to the virtual channel once the user has finished interacting with the media item or does not wish to continue interacting with the media item.

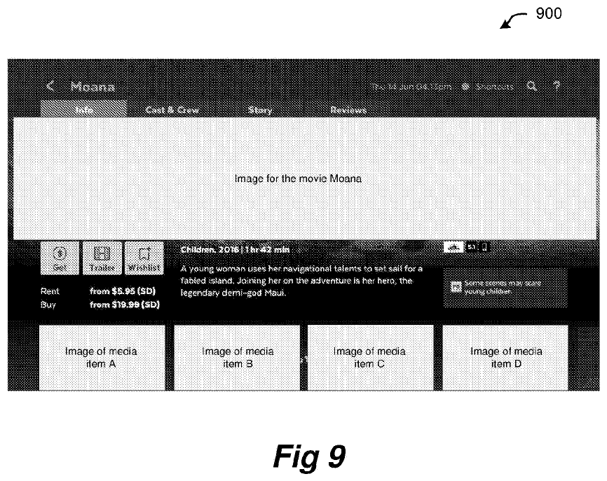

FIG. 9 illustrates an example user interface 900 that may be displayed when a subscriber 116 selects the “more info” feature displayed in FIG. 7 or 8. In this example, the client application 120 has navigated to the portion of the EPG that provides more information about each of the VOD media items available at the service provider. This user interface 900 provides more information about the movie ‘Moana’, information about the cast and crew, story and review about the movie. Further, the subscriber may be able to buy the movie or add it to their favorites/wish list.

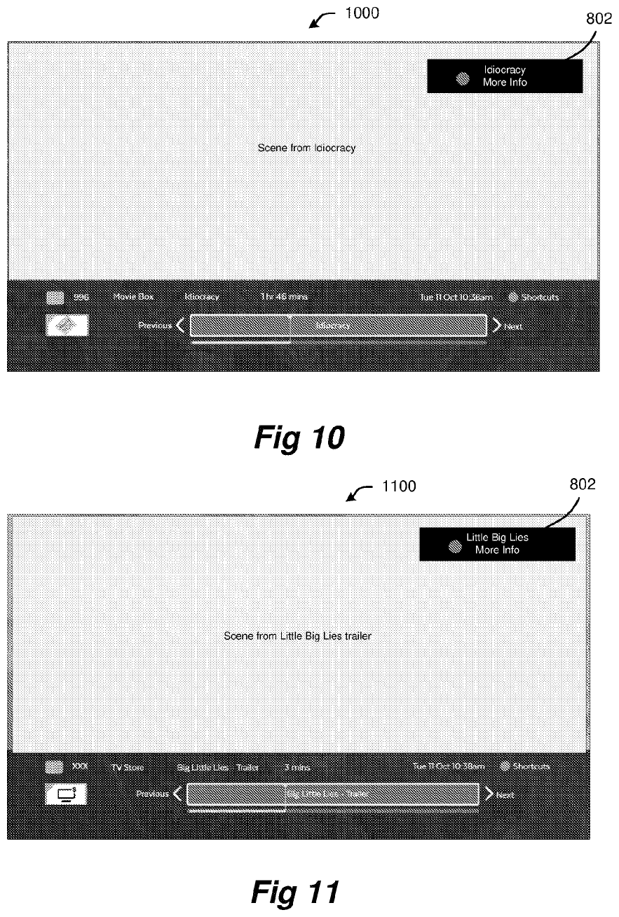

FIGS. 10-13 illustrate example screenshots 1000-1300 of different types of virtual channels with the “more information” affordance 802 displayed in the top right corner (FIGS. 10-12) or in the detailed information bar 702 (FIG. 13).

### Hardware overview

The operations/techniques described herein are implemented by one or more special-purpose computing systems or devices. For example, in environment 100: the asset management system, the content management system, and the IPG module 110 may be provided by one or more computer systems; each user device 112 is a computer system; and each of the content sources 106 may be provided by one or more computing systems.

The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hardwired logic, ASICs, or FPGAs with custom programming to accomplish the techniques. The special purpose computing devices may be set top boxes, desktop computer systems, portable computer systems, handheld devices, networking devices or any other device that incorporates hard-wired and/or program logic to implement relevant operations.

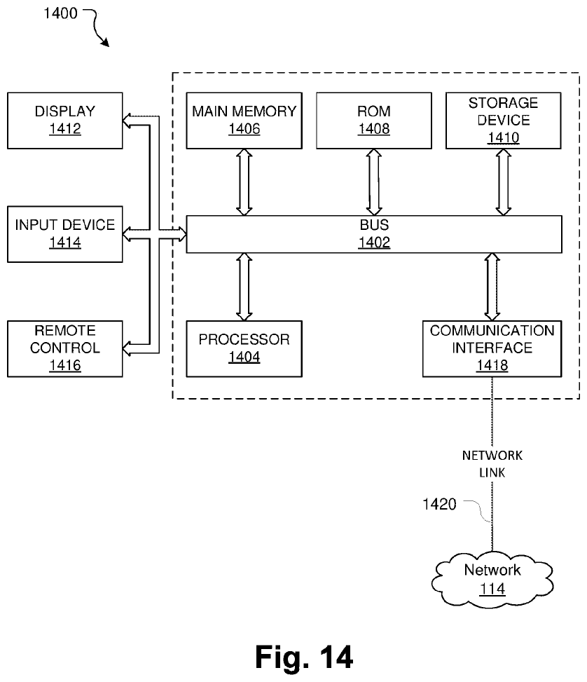

For example, FIG. 14 is a block diagram that illustrates a computer system 1400 upon which an embodiment of the invention may be implemented. Computer system 1400 includes a bus 1402 or other communication mechanism for communicating information, and a hardware processor 1404 coupled with bus 1402 for processing information. Hardware processor 1404 may be, for example, a general-purpose microprocessor or a special purpose microcontroller.

Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk or optical disk, is provided and coupled to bus 1402 for storing information and instructions. If the computer system 1400 is part of the user device 112, the storage device 1410 may store media content and channel and media content metadata.

Further, in case the computer system 1400 is the client device 112, it may be coupled via bus 1402 to one more output devices such as a display 1412 for displaying information to a subscriber. Display 1412 may, for example, be an external television or computer screen or an integrated touch screen display. An input device 1414, including alphanumeric and other keys, may be coupled to bus 1402 for communicating information and command selections to processor 1404. Another type of user input device is a remote control 1416 for communicating command selections to processor 1404. Additional and/or alternative input devices are possible, for example touch screen displays.

According to one embodiment, the methods disclosed herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hardwired circuitry may be used in place of or in combination with software instructions.

Computer system 1400 also includes a communication interface 1418 coupled to bus 1402. Communication interface 1418 provides a two-way data communication coupling to a network link 1420 that is connected to network 114. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks 114 to other computing systems. For example, if the computing system 1400 is the user device 112, the network link 1420 may provide a connection through network 114 to the content management system 104, the content distribution system 108 and the IPG module 110.

Computer system 1400 can send messages and receive media content and other data, including program code, through the network(s), network link 1420 and communication interface 1418. In the user device 112 example, the user device 112 receives channel and media item metadata and IPG information from the IPG module 110 and media items from the distribution system 108 through the network 114 and communication interface 1418.

Where reference is made in any one or more of the accompanying drawings to steps and/or features, which have the same reference numerals, those steps and/or features have for the purposes of this description the same function(s) or operation(s) unless explicit contrary instructions provided.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

As used herein the terms “include” and “comprise” (and variations of those terms, such as “including”, “includes”, “comprising”, “comprises”, “comprised” and the like) are intended to be inclusive and are not intended to exclude further features, components, integers or steps. Further, the terms “process” and “method” are interchangeably used.

Various features of the disclosure have been described using flowcharts. The functionality/processing of a given flowchart step could potentially be performed in various different ways and by various different systems or system modules. Furthermore, a given flowchart step could be divided into multiple steps and/or multiple flowchart steps could be combined into a single step. Furthermore, the order of the steps can be changed without departing from the scope of the present disclosure.

It will be understood that the embodiments disclosed and defined in this specification extends to all alternative combinations of two or more of the individual features mentioned or evident from the text or drawings. All of these different combinations constitute various alternative aspects of the embodiments.

What is claimed is:

1. A method, comprising:
at a content distribution system:
creating a virtual broadcast channel, the virtual broadcast channel comprising an ordered list of media items;
generating and associating a channel metadata descriptor with the virtual broadcast channel and a media item metadata descriptor with each media item in the virtual broadcast channel, the channel metadata descriptor comprising data indicating the order of play of the media items and the media item metadata descriptor comprising data indicating an action to be performed in association with a particular media item of the virtual broadcast channel;
forwarding the channel metadata descriptor and the media item metadata descriptors to multiple user devices for rendering an electronic program guide on the multiple user devices, the electronic program guide comprising a listing of the virtual broadcast channel;
receiving, from at least one of the multiple user devices, a request for a media item from the ordered list of media items, the media item scheduled to play at the current time, the request received in response to the at least one user device detecting selection of the virtual broadcast channel on the respective user device; and
retrieving and forwarding the requested media item to the at least one user device for rendering on a display associated with the respective user device.

2. The method of claim 1, wherein the virtual broadcast channel is created automatically based on a set of rules.

3. The method of claim 1, wherein the ordered list of media items includes media items hosted by a plurality of content distribution technologies.

4. A method comprising:
at a user electronic device:
playing a media item of a plurality of media items available in a virtual broadcast channel on a display associated with the user electronic device;
while playing the media item, displaying a user interface affordance for performing an additional action associated with the media item;
receiving indication of selection of the user interface affordance;
retrieving a media item metadata descriptor associated with the media item, the media item metadata descriptor comprising information for performing an action in association with the media item;
performing the corresponding action based on the information in the retrieved media item metadata descriptor; and
upon completion of the action, playing a currently scheduled media item of the plurality of media items available in the virtual broadcast channel.

5. The method of claim 4, wherein the corresponding action is displaying a user interface that provides additional information about the media item.

6. The method of claim 4, wherein the media item is associated with media content broadcast on another broadcast channel and the corresponding action is recording the media content broadcast on the other broadcast channel.

7. The method of claim 4, wherein the media item is associated with video on demand media content and the corresponding action is to display a user interface allowing a user to watch and/or purchase the video on demand media content.

8. The method of claim 4, wherein the media item is a video showing a functionality of an electronic program guide of the user device and the corresponding action is displaying a user interface of the electronic program guide corresponding to the functionality shown in the media item.

9. The method of claim 4, further comprising:
while displaying the media item of the virtual broadcast channel, receiving a request to navigate to a different media item of the virtual broadcast channel that is not currently scheduled to play;
requesting a service provider for the different media item, the request comprising a media identifier of the different media item;
receiving the different media item from the service provider; and
rendering the different media item on a display associated with the user device.

10. The method of claim 9, wherein receiving the request to navigate to a different media item is a request to navigate to a media item ahead in the schedule of play.

11. The method of claim 9, wherein receiving the request to navigate to a different media item is a request to navigate to a previously scheduled media item.

12. (canceled)

13. (canceled)

14. (canceled)

15. A non-transitory computer readable medium storing instructions, which when executed by a processor of an electronic device, cause the electronic device to:
play a media item of a plurality of media items available in a virtual broadcast channel, on a display associated with the user electronic device;
while playing the media item, display a user interface affordance for performing an additional action associated with the media item;
receive indication of selection of the user interface affordance;
retrieve a media item metadata descriptor associated with the media item, the media item metadata descriptor comprising instructions and data for performing an action in association with the media item;
perform the corresponding action based on the instructions and data in the retrieved metadata descriptor; and
upon completion of the action, return display of the user electronic device to the virtual broadcast channel and play a currently scheduled media item of the plurality of media items available in the virtual broadcast channel.

16. The non-transitory computer readable medium of claim 15, wherein the corresponding action is displaying a user interface that provides more information about the media item.

17. The non-transitory computer readable medium of claim 15, wherein the media item is associated with media content broadcast on another broadcast channel and the corresponding action is recording the media content broadcast on the other broadcast channel whenever the media content is aired.

18. The non-transitory computer readable medium of claim 15, wherein the media item is associated with video on demand media content and the corresponding action is to display a user interface allowing a user to watch and/or purchase to the video on demand media content.

19. The non-transitory computer readable medium of claim 15, wherein the media item is a video showing a functionality of an electronic program guide of the user device and the corresponding action is displaying a user interface of the electronic program guide corresponding to the functionality shown in the media item.

20. The non-transitory computer readable medium of claim 15, further storing instructions, which when executed by the processor of the electronic device cause the electronic device to:
while displaying the media item of the virtual broadcast channel, receive a request to navigate to a different media item of the virtual broadcast channel that is not currently scheduled to play;
request a service provider for the different media item, the request comprising a media identifier of the different media item;
receive the different media item from the service provider; and
render the different media item on a display associated with the user device.

21. The non-transitory computer readable medium of claim 20, wherein receiving the request to navigate to a different media item is a request to navigate to a media item ahead in the schedule of play.

22. The non-transitory computer readable medium of claim 20, wherein receiving the request to navigate to a different media item is a request to navigate to a previously scheduled media item.

23. (canceled)

24. (canceled)

25. (canceled)

26. (canceled)

27. The method of claim 4, further comprising:
at the user electronic device presenting an electronic program guide, wherein the electronic program guide is based on data received by the user device from a remote media system;
receiving at the user device interactions to display the electronic program guide, the electronic program guide including a first schedule for a broadcast channel and a second schedule for the virtual broadcast channel;
displaying the broadcast channel in the electronic program guide showing the individual media items of the broadcast channel arranged in a timeline according to the first schedule; and
displaying the virtual broadcast channel in the electronic program guide showing the currently playing media item of the broadcast virtual channel, wherein the currently playing media items extends across a display area of the electronic program guide over a greater extent than the duration of the item would indicate if displayed in the broadcast channel.
